(19) United States
(12) Patent Application Publication
(10) Pub. No.: US 2011/0186650 A1
(43) Pub. Date: Aug. 4, 2011

(54) Shower soap dispenser for liquid soaps

(76) Inventor: Robert Anthony Bishop, Enola, AR (US)

(21) Appl. No.: 12/657,992

(22) Filed: Feb. 1, 2010

(51) Int. Cl. B05B 7/26

(52) U.S. Cl. 239/310

(57) ABSTRACT

An improved shower soap dispenser for use with liquid soap, gels and body washes. It consists of a soap storage reservoir, main body containing control valves that intersects and connects directly to a conventional shower pipe and shower head. It mixes an adjustable amount of liquid with air into the flowing water. Its improved main valve with greater vacuum ability that is multi-functional and multi-positional with new “self cleanout” position and “off/trickle” position, which now can also be used with a hand held shower hose unit. Yet another dispenser improvement, it can now be operated from a sitting position by someone who is physically challenged, handicapped or unable to stand. This can be new bathing independence in the shower for many people who previously had to rely on an assistant to help them bath.

### BACKGROUND OF THE INVENTION

1. Field of the Invention

The present invention relates to improvements to liquid dispensers used primarily to deliver soap onto a bather in a conventional shower.

2. Prior Art

Although these improvements relate directly to one patented soap dispenser (Bishop U.S. Pat. No. 5,356,076) it will become obvious that these improvements can apply to and improve many other patented liquid dispensing devices, both past and present.

### SUMMARY OF THE INVENTION

It is the object of this present invention to provide improvements to soap dispensing devices used in conventional showers, that inter connects to a source of pressurized water and a reservoir of liquid soap, gels or body wash, and shower head or hand held shower hose unit. There are four independent improvements that will be defined in drawings and in detail.

1st—An improved main valve that produces greater vacuum at lower than optimum water pressures (often the case in rural areas and houses that rely on their own individual well for water), while at the same time this same valve produces exceptional water volume flow in the rinse position.
2nd—An improved reconfiguration, arrangement and addition of part(s) that makes this inventions single handle and single lever mechanism easy to use by a person who is (or is not) physically handicapped. Especially, but not limited to, a person who can only bathe in a seated position.
3rd—An improvement that allows for the main valve to be rotated 180 degrees from its “soap” position to a newly constructed “clean out” position in which the incoming water pressure will be directed in reverse through the main valve.
4th—An improvement that allows for soap dispenser to always have a trickle of water in the “off position” to prevent possible scalding and conform with U.S. plumbing codes.

Although the original patent, Bishop U.S. Pat. No. 3,356,076, works well with a wide range of water pressures, and a wide variety of liquid soaps, the changing market place with the introduction of thicker viscosity soaps, such as gels, body washes and scrubs, has led to the development of this newly improved valve.

Reference and for illustration purposes of these above liquid soap dispenser improvements, U.S. Pat. No. 5,356,076 Bishop, will be used.

Note to examiner:

Working models and or parts available upon request for original and/or improved models.

### BRIEF DESCRIPTION OF THE DRAWINGS

FIG. 1A: A front view of handicap version of soap dispenser with off set handle 54 and removable extension lever 55, insert attached. In accordance with the present invention improvement.

Insert: Soap reservoir 10 and shower head 6.

FIG. 1B: Side view of handicap version of soap dispenser with handle 54 and extension lever 55 in the “soap” position.

FIG. 1C: Side view of handicap version of soap dispenser with handle 54 and extension lever 55 in “rinse” position.

FIG. 2A: Side view of original version of soap dispenser in “soap” position.

FIG. 2B: Side view of original version of soap dispenser in new “off-trickle” position.

FIG. 2C: Side view of original version of soap dispenser in “rinse” position.

FIG. 2D: Side view of original version of soap dispenser in new “clean-out” position.

FIG. 3A,B,C and D: Are internal side views of the main valve, 4 positions; Left to right: FIG. 3A: “soap” position, FIG. 3B: new “off-trickle” position, FIG. 3C: “rinse” position, and FIG. 3D: new valve “clean-out” position.

These 4 valve positions and its functions will remain the same regardless of which handle is used, original version 49 or handicap version 54, or its positioning on dispenser shown in these drawings, FIGS. 3A,B and C.

FIG. 4A: Detailed view of main valve 61 shown from water entrance side of valve in “soap” position with “V” grove notching 56.

FIG. 4B: Detailed view of main valve 61 shown from exit side of valve in “soap” position with “V” grove notching 57.

FIG. 5: Is main valve 61 illustrating section line 6-6.

FIG. 6: Is a section view of main valve 61, taken along section line 6-6 in FIG. 5.

FIG. 7: Is a section view of main valve 61 taken along section line 7-7 in FIG. 8.

FIG. 8: Is main valve 61 illustrating section lines 7-7 and 9-9.

FIG. 9: Is a section view of main valve 61 taken along section line 9-9 in FIG. 8.

### DETAILED DESCRIPTION OF THE INVENTION

It is the object of this invention to provide an improved shower soap dispenser capable of dispensing liquid soaps, thick viscosity gels and body washes, for use primarily in a shower. A dispenser that works in an extremely wide variety of water pressures while still delivering an exceptional and desirable flow of water in the “rinse” position (clear water only). This is now accomplished with the newly designed and constructed main valve 61, as described and illustrated in the claims and drawings.

It is yet another object and separate improvement of this liquid soap dispenser to make it available, easy to use and convenient for a person that is physically challenged or handicapped. This is done by allowing the person to shower in a sitting position and still use the soap dispenser. Here they will be able to control the selector handle 54 with extension lever 55. Their showering experience here can be pleasantly enhanced with the use of a hand held shower unit (not shown or supplied) in place of a standard shower head. This is certainly a desirable choice for a handicapped person:

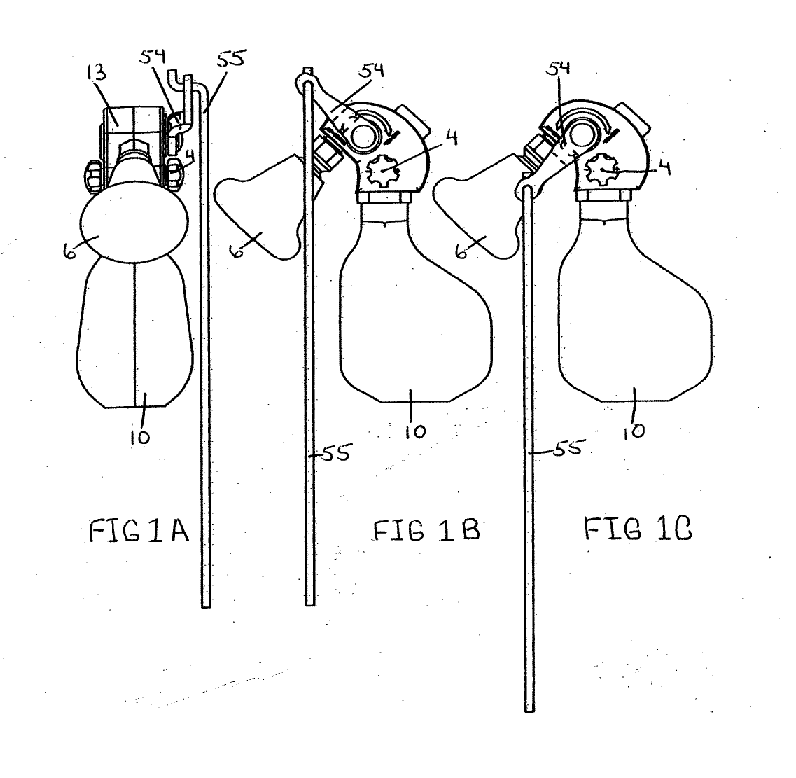

First—they can be seated, point the shower hose spray unit away from their body (example floor or side wall of shower)
Second—Turn on water supply valve(s), adjust the water to a comfortable temperature.
Third—Commence bathing and introduce the soap by means of actuating a single handicapped lever 55 attached to the extension handle 54 FIG. 1A.

As one can see by using a hand held shower hose unit here, instead of a standard shower head, there would be no sudden blast of cold or hot water onto the bathers body. Also, a handicapped person would not have to hurry to enter or exit an already running shower. In this situation the liquid soap dispenser still operates as usual (“soap”, “off-trickle”, “rinse” positions). Depending on the extent of a persons handicap or situation this can be a new or renewed freedom and privacy in the shower.

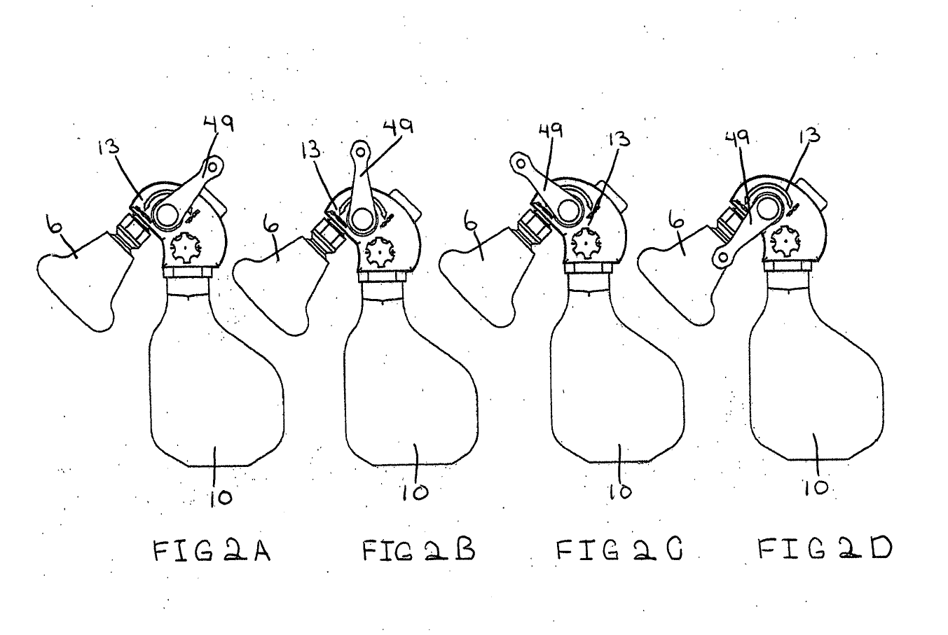

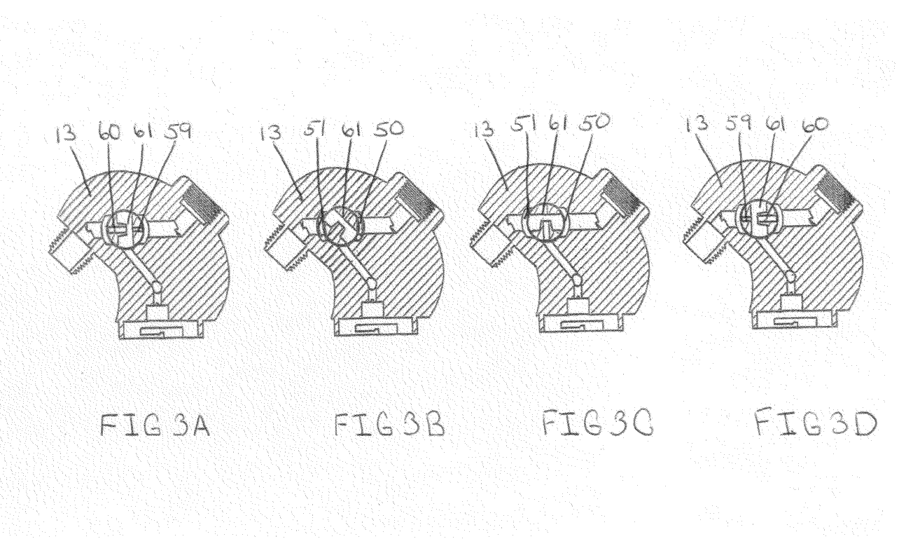

Yet another separate improvement is a new “off-trickle” position FIGS. 2D and 3D. This replaces the positive “off” position in prior art. This allows for a small amount of water to be always flowing. This is done for 2 reasons:

First—to prevent scalding which could occur in certain instances, example:
A. Location of water heater in relationship and distance to shower
B. Temperature setting on water heater
C. The amount of time a shower is paused in the off position before resuming the rinse Position.
   Second—United States plumbing code requirements that shower heads with a pause mode must not shut water off completely.

Another separate improvement to rotary main valve soap dispensers is the new “clean-out” position, FIGS. 2D and 3D of the main valve 61. Should it ever become clogged, the main valve 61 can now be rotated 180 degrees from the “soap” position, FIGS. 2a and 3A, now pressurized water can be used to clean out the main valve 61 by forcing water through it in reverse. It should also be noted here that main valve passages 59 and 60, FIG. 3A, are of different sizes and that passage 59 will always be a smaller diameter than passage 60 in order for the vacuum function to work. So therefore, in the “clean-out” position FIG. 3D, the larger passage 60 will back flush the smaller passage 59 with pressurized water.

### DESCRIPTION OF THE PREFERRED EMBODIMENT

The preferred embodiment is that of, U.S. Pat. No. 5,356,076 Bishop, Shower Soap Dispenser for Liquid Soaps.

All claims herein are improvements or modifications to this type of liquid dispenser.

Although particular embodiments have been described, it will be appreciated by those skilled in art that the present invention is not limited merely to those embodiments shown. Many variations and modifications can be made without departure from the spirit of the present invention. For example, the materials, the particular shapes, and the arrangement of the body and the shape and arrangements of the valves, as well as their particular locations, can be changed from those which are specifically illustrated. These and other variations are specifically contemplated. Accordingly, variation of the preferred form and the particulars as described for the present invention may be undertaken without departure from the scope of the invention which is defined only by the claims which follow.

What is claimed is:

1. Improved liquid soap dispenser with improved main multi-functional valve 61 that produces a stronger vacuum and thus a greater suction force at lower water pressures. This new internal valve design with its truncated cone 58 configuration also allows for exceptional water flow rate in the “rinse” position that far exceeds the United State Plumbing Code for maximum allowable gallons of water per minute (GPM), for shower heads. Inside the improved main valve 61 is a much closer proximity of passages 59 and 60 and this is the key factor in the improved vacuum function of this main valve 61.

2. Improved version of a liquid soap dispenser that can now be used by an individual that is physically challenged or handicapped. This improvement adds considerable versatility to the soap dispenser as it can know be used in a seated or sitting position. This is accomplished by:
A. Repositioning the main valve handle 54 (this is best done at time of manufacture) so that it is parallel to the shower floor which is the “off-trickle” position, and is located halfway through its full range of travel, between the “soap” and “rinse” positions. This allows for optimum leverage when handicap handle 54 is engaged with extension lever 55. Also, putting an offset in the handle 54 FIG. 1A, will give the user the added convenience and clearance when using a hand held shower hose unit in place of a standard shower head.
B. Adding a single handicap extension lever 55 that is inserted or attached to the selector handle 54. This lever 55 is of sufficient length to give easy access and control of the soap dispenser to a person who is seated in a shower area. This lever 55 can be attached permanently or can be easily removable as shown in FIGS. 1A and 1B.
Obviously this soap dispenser can still be operated in a standing position if the handicapped person shares the shower with others.

3. Improved liquid soap dispenser with rotary main valve 61 that can be back flushed by turning the selector handle 49 to a new “clean-out” position 2D. This is accomplished by rearranging handle stop(s) so as to allow the main valve to rotate 180 degrees from the “soap” position, as shown in FIG. 2D and FIG. 3D on the original version of the soap dispenser. NOTE: on the handicap version of the soap dispenser FIG. 1A,B,C the offset in this handle 54 is essential for clearance in order to clear the air valve knob 4 when handle 54 is rotated 180 degrees from the “soap” position to the “clean-out” position.

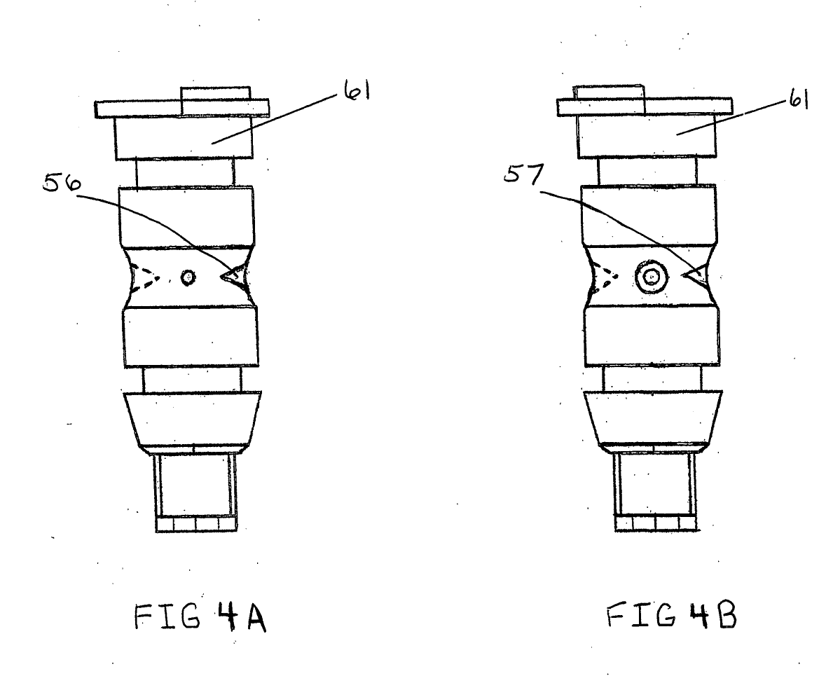

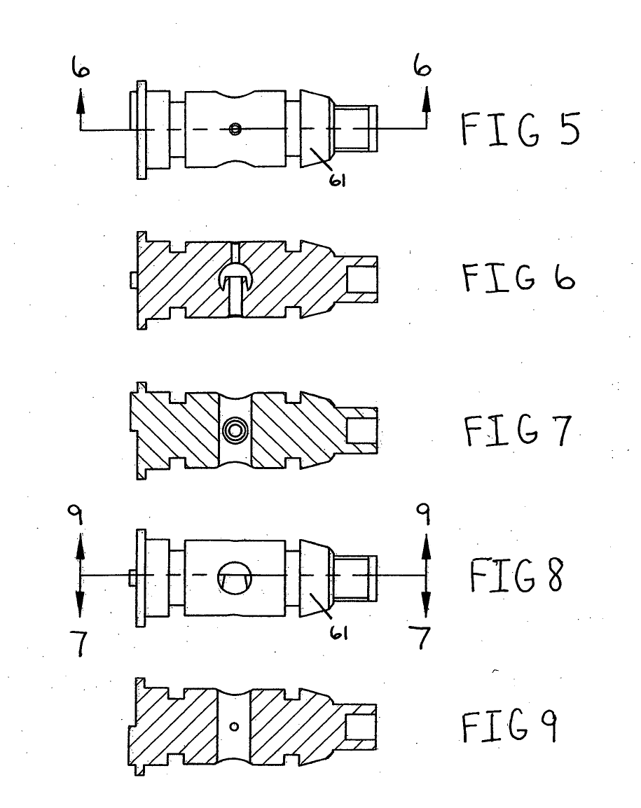

4. Improved liquid soap dispenser with rotary main valve 61. This improvement changes the “off” position by adding a trickle of water that will always be present in this position to prevent scalding, which might occur in certain instances. This position will now be referred to from here on and in drawings as the “off-trickle” position. This is accomplished by two small notches or indentations 56 and 57 located on the main valve 61 shown in FIGS. 4A and 4B. These notches serve to defeat a positive “off” position that was accomplished by stopping the selector handle 49 half way between to “soap” and “rinse” positions, whereas, o-rings 50 and 51 located in the dispenser body 13 created a positive “off” position as shown in FIG. 2B and FIG. 3B. This positive “off” position was present in the original version of the soap dispenser shown in FIGS. 2B, as well as FIGS. 3B.
